(19) United States
(12) Patent Application Publication
(10) Pub. No.: US 2003/0133550 A1
(43) Pub. Date: Jul. 17, 2003

(54) Incoming facsimile routing using text and image analysis

(76) Inventors: Gadi Mazor, Ramat Efal (IL); Ron Maor, Hertzlia (IL)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 09/479,997

(22) Filed: Jan. 10, 2000

(30) Foreign Application Priority Data
Jan. 10, 1999 (IL) 127982

(51) Int. Cl. H04M 11/00

(52) U.S. Cl. 379/100.06

(57) ABSTRACT

There is disclosed a system and method for the automatic routing of incoming facsimiles (faxes) to their intended recipients. The faxes are received by a fax server and the routing information is automatically determined by analysis of the fax pages. The fax is converted into data in the fax server, whereby it is routed to the intended recipient, for example, in an electronic format such as electronic mail (e-mail). The system does not impose any constraints on the content of the faxes or their sending mechanism, and is thus transparent both from the sender's viewpoint and the recipient's.

### FIELD OF THE INVENTION

The present invention is directed to systems for atomically routing incoming facsimiles (faxes) to their intended recipients. In particular, the present invention is directed to methods and apparatus for automatically routing incoming faxes by analyzing each of the facsimile (fax) pages.

### BACKGROUND OF THE INVENTION

It has been long desired to route Incoming faxes at the fax server. Several solutions have been proposed, each with significant drawbacks. U.S. Pat. No. 5,127,047 (Bell, et al.) proposes using the control section of the fax as a means for the sender to specify the recipient, as does U.S. Pat. No. 5,838,461 (Hsieh). U.S. Pat. No. 5,287,199 (Zoccolillo) suggests using this information and/or pre-arranged routing information stored in the processor. U.S. Pat. No. 5,247,591 (Baran) uses a standardized cover sheet to state the intended recipient.

All these methods, while theoretically feasible, force the sender to use a special sending method or cover sheet. In practice, the recipient exerts little control over the format and sending protocol of faxes from different senders.

U.S. Pat. No. 5,461,488 (Witek) describes a system with such capabilities. However, the description given skips the actual routing and gives no indication that it can be done, simply stating that a ‘program determines, from the file, a destination of the fax document.” If the program, as implied in that patent application, simply searches the text for the name of a recipient, then the result is potentially a misroute to a person mentioned in the fax text who is not the recipient.

### SUMMARY OF THE INVENTION

The present invention overcomes the problems associated with the prior art by providing systems and methods for routing a facsimile (fax) message based on the message itself, rather than additional information which may not be present. A system for performing the present invention includes a fax server, for receiving faxes that utilizes an algorithm to automatically route these incoming facsimiles to their intended recipients. The recipients typically receive these faxes in forms including electronic mail (e-mail) on their personal computers or other e-mail receiving devices, such as Personal Digital Assistants (PDAs). The routing is achieved by the determination of routing information, automatically determined by analysis of the fax pages. The system imposes no constraints on the content of the faxes or their sending mechanism, and is thus transparent both from the sender's viewpoint and the reciplent's.

The invention is also directed to a method for routing at least one facsimile page to at least one recipient with the steps of dividing said at least one facsimile page into blocks, converting this at least one facsimile page into data, isolating at least one of these blocks as a recipient block, locating the address of the at least one recipient by analyzing the recipient block and analyzing address data to determine an address corresponding to the at least one recipient, and sending the facsimile page data to the at least one recipient at the located address.

The invention also discloses a system for routing at least one facsimile page to at least one recipient. The system includes a fax server, that includes a storage unit including an address database and a data processor programmed to divide the at least one facsimile page into blocks and convert the at least one facsimile page into data, isolate at least one of the blocks as a recipient block, and locate the address of the at least one recipient by analyzing the recipient block and analyzing the address database to determine an address corresponding to the at least one recipient. There is also a transmitter in communication with the data processor for sending the facsimile page data to the at least one recipient at the located address.

### BRIEF DESCRIPTION OF THE DRAWINGS

The present invention will be described with reference to the accompanying drawings, wherein like reference numerals or like reference characters indicate corresponding or like components. In the drawings:

FIG. 1 is a block of the system of the present invention;

FIG. 2a is a sample company address book in accordance with the present invention;

FIG. 2b is a sample resulting name space in accordance with the present invention;

FIG. 3 is a sample fax with the recipient identified in accordance with the present invention; and

FIG. 4 is a screen shot of an electronic mail communication (e-mail) resulting from the method of the present invention.

### DETAILED DESCRIPTION OF THE DRAWINGS

The present invention includes apparatus and methods automatically routing incoming faxes by analyzing each of the facsimile (fax) pages. The apparatus disclosed can be used to form systems for performing the methods disclosed herein.

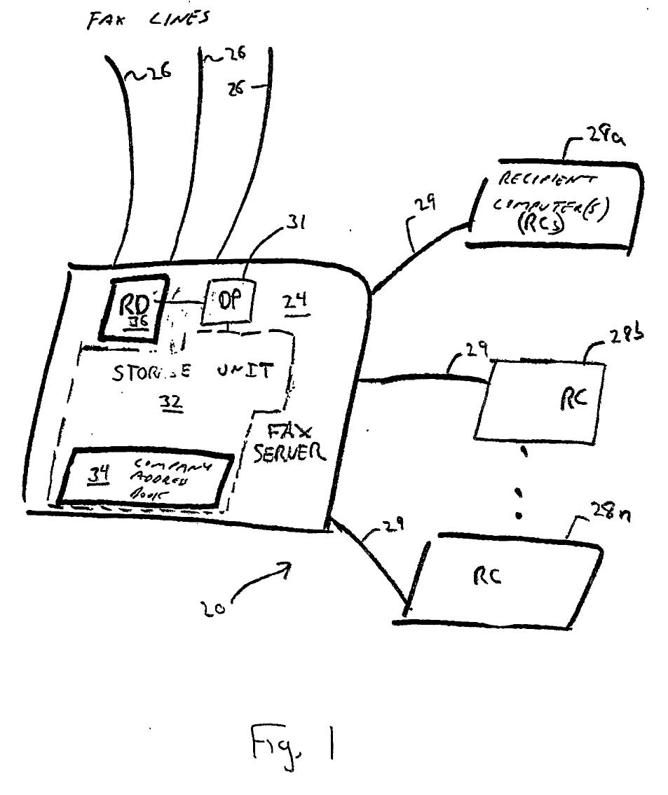

FIG. 1 shows a system 20 in accordance with the present invention. The method of the present invention is typically carried out by software or software means (data) executable on computing (data processing) means, such as a computer (PC), microprocessors, embedded processors, microcomputers, microcontrollers, etc.

The system is formed of a fax server 24 that receives facsimiles (faxes) from at least one fax line 26. The faxes are routed to the specific recipient computer (RC) 28a-28n (“n” representing a plurality of units), electronically linked (illustrated by lines 29) to the fax server 24.

The fax server 24 is such that preferably therein is a data processor (DP) 31 electronically linked to a storage unit 32 for storing programs and other related software, databases (one such database being a company address book 34), data, etc. The data processor 31 is electronically linked to a reading means (RD) 36, typically a OCR such as that in a package with a parser, such as ExperVision's Recognition Tool Kit, or the like, for reading the incoming fax received over the fax lines 26 and dividing the text thereof into portions, for analysis by the software, associated databases and data, in the storage unit 32, in conjunction with the company address book 34. Once this analysis (detailed below) is complete, the routing for the fax, or portions thereof, is determined, such that the fax or portions thereof, is sent to the correct recipient computer (RC) 28a-28n, in accordance with the routing information.

The data processor 31 functions to process data input from the storage unit 31 and the reading means 36. Processing includes performing operations, preferably by executing algorithms, for performing the method of the present invention. An exemplary algorithm, typically in the form of software or data, is detailed as follows.

Process No. 1

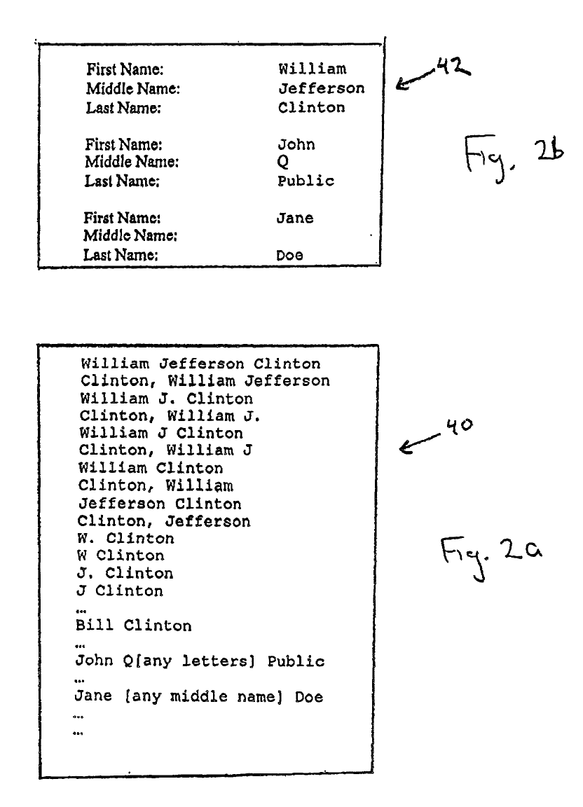

Before the program analyzes any fax messages, it receives the company address book. It converts the address book into an Address Book Name Space, as detailed in our Israel Patent Application entitled: Generation Of An Address Book Name Space, filed on even day herewith, incorporated by reference in its entirety herein. FIG. 2a shows a sample 40 of the company address book 34 (FIG. 1), while a sample of the resulting name space 42 from this sample 40 from the company address book 34 is shown in FIG. 2b.

Process No. 2

When a fax message is received on the server, the next process Is that this program deskews each of the fax pages for further processing. This is performed in accordance with the method detailed in our Israel Patent Application entitled: Method For Efficient Auto-Deskew Of Pages, filed on even date herewith, incorporated by reference in its entirety herein.

Process No. 3

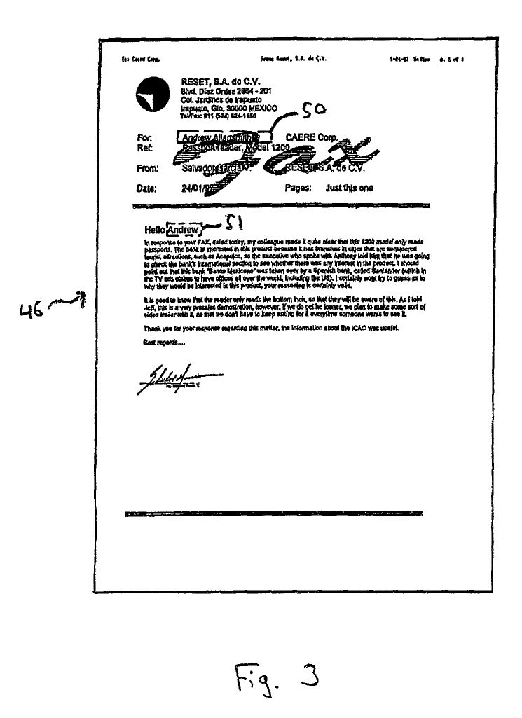

The next process is the actual analysis of the fax. The analysis is carried out first on the first page of the fax document 46, as shown in FIG. 3. This analysis consists of Block Classification of the fax document 46, as detailed in our Israel Patent Application, entitled: Block Classification Of Facsimile Pages, filed on even date herewith, incorporated by reference in its entirety herein,

Process No. 4

Based on the block classification of the fax that was the output of the previous step, blocks 50, 51, these parts corresponding to the recipient are isolated, in accordance with this Block Classification. The above detailed classification has marked block 50 as a “To Part” and block 51 as a “Dear Part” respectively. The software now searches for the corresponding recipient in the Address Book 34 in accordance with the block classification method detailed above.

Process No. 5

Using all the names from the Address Book Name Space 42 that were found on the fax 46, the fax 46 is routed to the recipient computers 28a-28n belonging to the recipients with those names as per the address book 34.

Process No. 6

If no recipients were found on the first page of the fax, and the fax was more than one page long, Processes 3, 4 and 5 are repeated on the next page.

This series of processes achieves, conversion of the fax 46 into data and routing this data to the intended recipient, without routing to possible recipients, who may be mentioned in other parts of the fax 46. This data is typically in an electronic format, such as electronic mail (e-mail) to be received by the intended recipient on his personal computer 28a-28n, or alternately, other e-mail receiving device such as Personal Digital Assistants (PDAs).

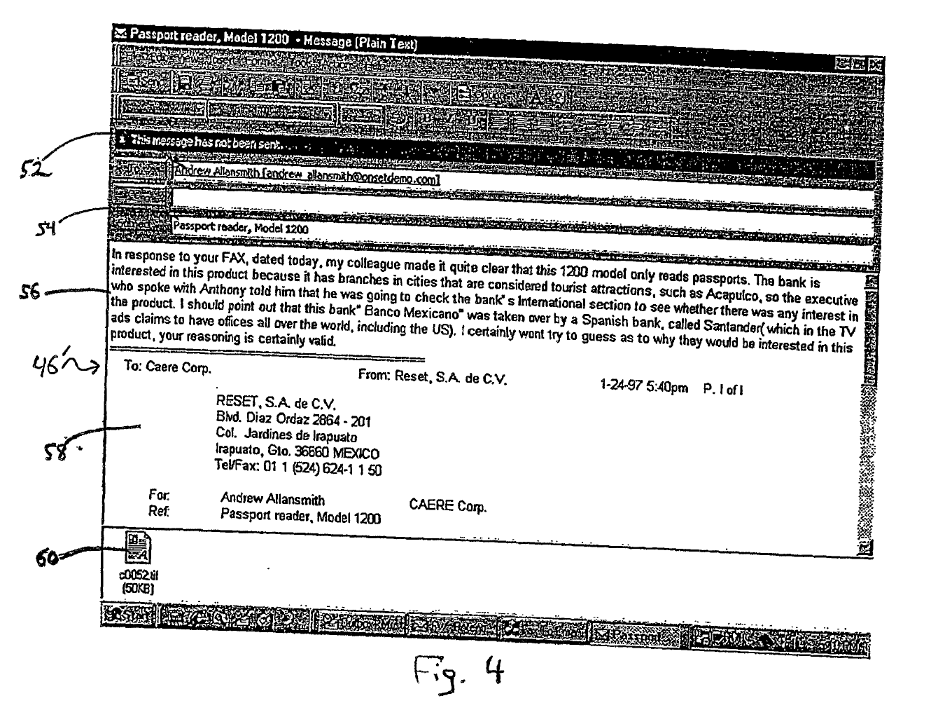

An exemplary e-mail document 46′ corresponding to the fax 46 (FIG. 3) is shown in FIG. 4. This document 46′, shown as a screen shot, shows the e-mail message that corresponds to the fax 46 of FIG. 3, that includes an identified recipient 52 (in the “To:” space), an identified subject 54 (in the “Subject” space), a text paragraph 56 (here, the first significant text paragraph), the full text of the fax 58, and the attached original fax image 60.

While preferred embodiments of the present invention have been described so as to enable one of skill in the art to practice the present Invention, the preceding description is exemplary only, and should not be used to limit the scope of the invention. The scope of the invention should be determined by the following claims.

What is claimed Is:

1. A method for routing at least one facsimile page to at least one recipient comprising the steps of:
dividing said at least one facsimile page in to blocks;
converting said at least one facsimile page into data;
isolating at least one of said blocks as a recipient block;
locating the address of said at least one recipient by analyzing said recipient block and analyzing address data to determine an address corresponding to said at least one recipient; and
sending said facsimile page data to said at least one recipient at said located address.

2. A system for routing at least one facsimile page to at least one recipient comprising:
a fax server including,
a storage unit including an address database;
a data processor, said data processor programmed to:
divide said at least one facsimile page In to blocks;
convert said at least one facsimile page into data;
isolate at least one of said blocks as a recipient block;
locate the address of said at least one recipient by analyzing said recipient block and analyzing said address database to determine an address corresponding to said at least one recipient; and
a transmitter in communication with said data processor for sending said facsimile page data to said at least one recipient at said located address.
